(19) United States
(12) Patent Application Publication
(10) Pub. No.: US 2009/0256400 A1
(43) Pub. Date: Oct. 15, 2009

(54) Device for positioning and locking a duct in a hollow body and beam of a dashboard cross-member provided with such a device

(75) Inventor: Albin Descamps, Meru (FR)

Correspondence Address: YOUNG & THOMPSON, 209 Madison Street, Suite 500, ALEXANDRIA, VA, 22314, US

(73) Assignee: FAURECIA INTERIEUR INDUSTRIE, NANTERRE (FR)

(21) Appl. No.: 11/991,158

(22) PCT Filed: Aug. 17, 2006
(86) PCT No.: PCT/FR2006/001957

§ 371 Date: Feb. 28, 2008

(30) Foreign Application Priority Data
Aug. 31, 2005 (FR) 0508939

(51) Int. Cl. F16L 7/00; B62D 25/14

(52) U.S. Cl. 296/205; 403/376

(57) ABSTRACT

A device for positioning and locking a duct (20) in a hollow body (10), the hollow body (10) includes a passage for sliding the duct (20) into the body (10) and a plate (13) for fixing the body (10) and forming a limit stop for the duct (20). The inventive device includes a projecting element (22) on the end of the duct (20) that is intended to be applied against the plate (13), a slot (15) in the plate (13) having an essentially complementary shape to that of the projecting element (22) and members for locking the projecting element (22) in the slot (15). The invention is suitable for motor vehicle dashboard crossmember beams.

The present invention relates to a device for positioning and locking a duct in a hollow body, such as, for example, a ventilation duct in a beam of a dashboard cross-member of a motor vehicle.

The invention also relates to a beam of a dashboard cross-member comprising a ventilation duct which is retained by such a device.

In a number of industrial fields, ducts, such as, for example, ventilation ducts, are placed in hollow bodies which comprise a channel which extends along the length of the hollow body and which is intended to receive this duct.

This is the case, for example, for the beam of a dashboard cross-member of a motor vehicle, which forms a channel along the length of the beam which comprises a ventilation duct.

In this manner, dashboard cross-members, in addition to their function in terms of the rigidity of the vehicle, are used to convey the flow of air from the climate-control unit or the heating device. They therefore comprise a duct of insulating material to channel this flow of air to the passenger space, with the heat properties thereof being retained.

The beam of dashboard cross-members is generally of metal, with the result that passing air directly into the beam brings about significant heat losses of the air transported. It is therefore necessary to line the metal beam with a material which is less conductive than metal. It is for this reason that beams for cross-members of dashboards of motor vehicles most often comprise a ventilation duct of rigid plastics material arranged inside the beams.

However, the introduction and the positioning of a duct of this type presents problems since it most often involves an assembly operation which is carried out blind, which does not allow the ventilation duct to be positioned in a precise manner in all directions, which presents problems for the arrangement of the other components on the dashboard, such as, for example, the vents.

Furthermore, it is necessary to retain the duct in the beam of the cross-member in order to prevent this duct from vibrating or moving inside this beam.

To this end, a beam for a dashboard cross-member is known in which the inner duct is over-moulded with a plastics material in the beam.

However, this embodiment is complex to implement, particularly in the case of large-scale production.

A metal beam is also known which comprises at least one tubular channel and in which the inner duct is introduced by means of sliding, so that it has no protruding portion.

In this instance, the problem arises of positioning the inner duct and connecting this duct relative to the vent whilst complying with the ventilation restrictions of the assembly.

The object of the invention is therefore to overcome this problem.

The invention therefore relates to a device for positioning and locking a duct in a hollow body, the hollow body comprising, at a first end, a passage for introducing the duct into this hollow body by means of sliding and, at a second end, a plate for fixing the hollow body, forming a stop for the duct, characterised in that it comprises a protruding element which is provided at the end of the duct which is intended to be pressed against the plate, a cut-out which is provided in the plate and which has a shape which substantially complements the protruding element and means for locking the protruding element in the cut-out.

According to other features of the invention:
the protruding element is formed by an L-shaped lug,
the cut-out comprises an edge which extends substantially perpendicularly relative to the plate and which is directed towards the outer side of the plate relative to the direction in which the duct is introduced into the hollow body, and
the locking means are formed by at least one screw element for fixing the lug to the edge.

The invention also relates to a beam for a motor vehicle dashboard cross-member, comprising a ventilation duct, characterised in that the ventilation duct is positioned and locked by at least one device as mentioned above.

The invention will be better understood from a reading of the following description, given purely by way of example and with reference to the appended drawings, in which:

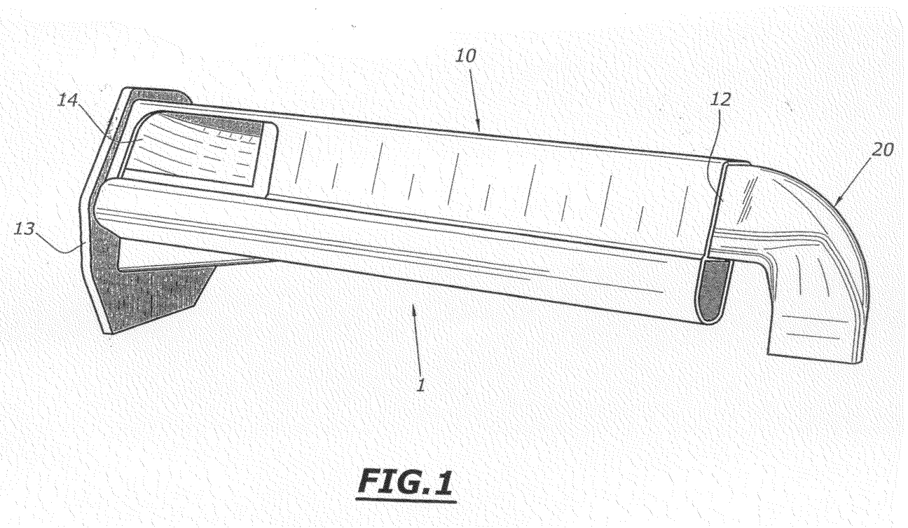

FIG. 1 is a schematic, perspective view of a portion of a motor vehicle dashboard cross-member comprising a beam and a ventilation duct which are provided with a positioning and locking device, according to the invention,

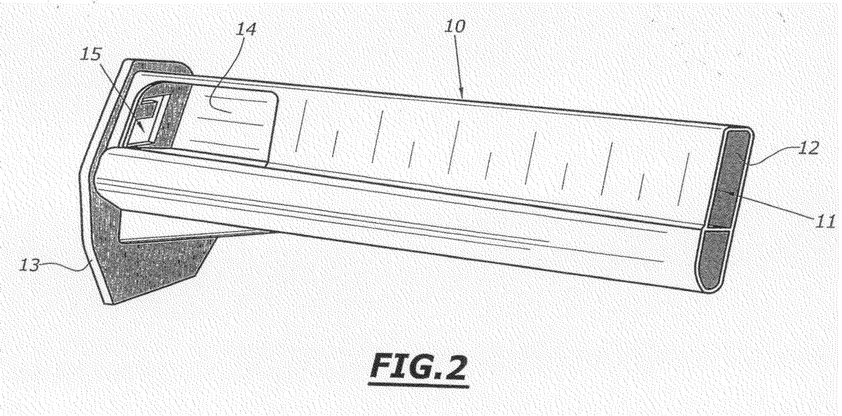

FIG. 2 is a schematic perspective view of the beam of the cross-member,

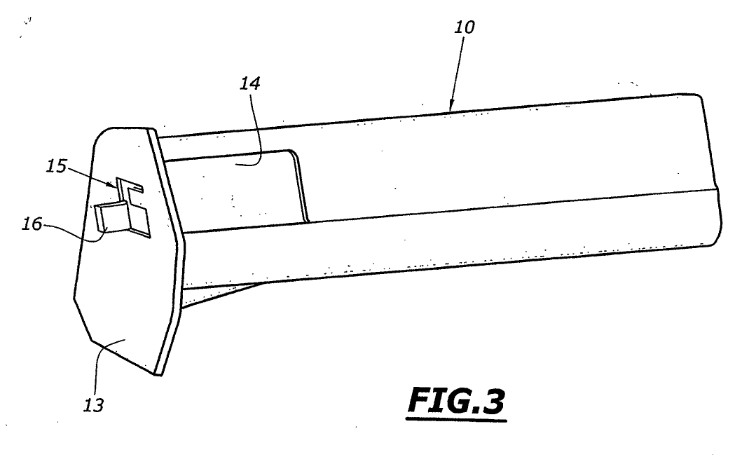

FIG. 3 is a schematic, perspective view of the end plate of the beam,

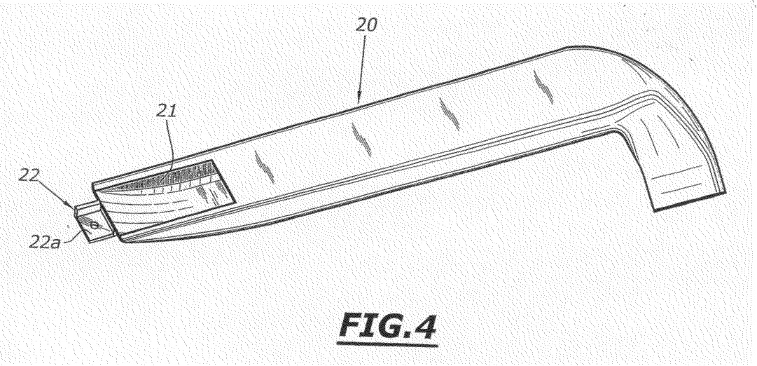

FIG. 4 is a schematic, perspective view of the ventilation duct of the cross-member, and

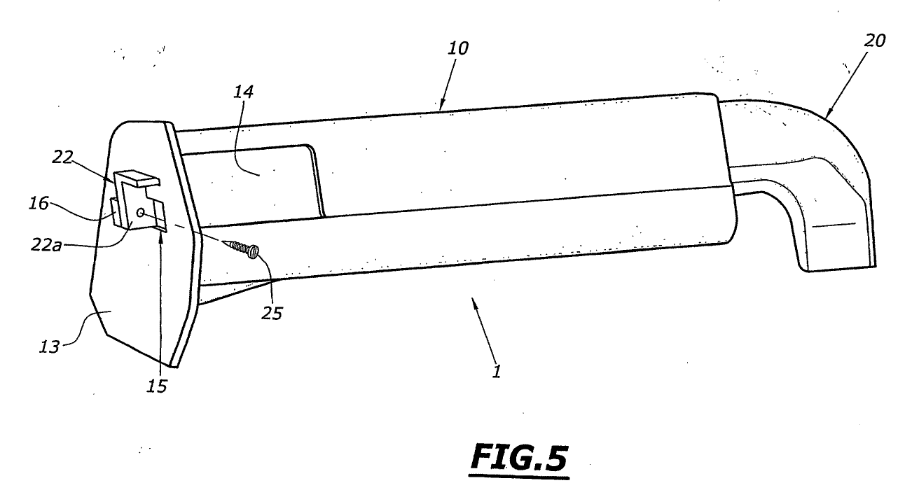

FIG. 5 is a schematic, perspective view illustrating the positioning and locking device with the ventilation duct placed in the beam.

FIG. 1 schematically illustrates a portion of a motor vehicle dashboard cross-member which is generally designated 1. In conventional manner, this cross-member performs a structural function for the vehicle, that is to say, it contributes to the strengthening of the structure of this vehicle. It also conveys air to the vehicle passengers and finally supports some components, such as a steering column and an airbag safety device.

The cross-member 1 comprises a beam which is generally designated 10 (FIG. 2) and a ventilation duct which is generally designated 20 (FIG. 4).

The beam 10 which constitutes a hollow body is in the form of a profile-member which forms a channel 11 along the length of this beam and which comprises, at a first end, a passage 12 for introducing the duct 20 into the channel by means of sliding. The beam 10 also comprises, at a second end, a plate 13 for fixing to the structure of the body of the motor vehicle.

This plate 13 constitutes a stop for the duct 20 when it is positioned in the channel 11 of the beam 10. The beam 10 is also provided with an opening 14 which is arranged on the face of the beam 10 which is intended to be directed towards the passenger space of the vehicle, for the positioning of a vent, which is not illustrated.

As shown in FIG. 3, the end plate 13 of the beam 10 comprises a cut-out 15 which is generally L-shaped. This cut-out 15 comprises an edge 16 which extends substantially perpendicularly relative to the end plate 13 and which is directed towards the outer side of the plate 13 relative to the direction in which the duct is introduced into the channel 11 of the beam 10.

The ventilation duct 20 produced from a rigid insulating material also comprises an opening 21 which is intended to be placed opposite the opening 14 of the beam 10 in order to diffuse air inside the passenger space via the vent.

As illustrated more specifically in FIG. 4, the end of the duct 20 which is intended to be pressed against the end plate 13 of the beam 10 comprises a protruding element which is formed by an L-shaped lug 22.

The cut-out 15 and the lug 22 therefore have a substantially complementary shape.

When the ventilation duct 20 is introduced into the channel 11 via the opening 12 of the beam 10, the end of the duct 20 moves into abutment against the plate 13 and the lug 22 extends through the cut-out 15, as illustrated in FIG. 5.

In this position, the branch 22a of the lug 22 covers the edge 16 of the end plate 13 and the locking of the duct 20 inside the beam 10 is carried out by locking means which are formed by at least one screw 25 (FIG. 5) which extends through the branch 22a of the lug 22 and which penetrates into the edge 16.

The device according to the invention therefore allows the ventilation duct to be positioned correctly in all directions using means which can be implemented in an economical and simple manner.

1. Device for positioning and locking a duct (20) in a hollow body (10), the hollow body (10) comprising, at a first end, a passage (12) for introducing the duct (20) into this hollow body (10) by means of sliding and, at a second end, a plate (13) for fixing the hollow body (10), forming a stop for the duct (20), characterised in that it comprises a protruding element (22) which is provided at the end of the duct (20) which is intended to be pressed against the plate (13), a cut-out (15) which is provided in the plate (13) and which has a shape which substantially complements the protruding element (22) and means (25) for locking the protruding element (22) in the cut-out (15).

2. Device according to claim 1, characterised in that the protruding element is formed by an L-shaped lug (22).

3. Device according to claim 1, characterised in that the cut-out (15) comprises an edge (16) which extends substantially perpendicularly relative to the plate (13) and which is directed towards the outer side of the plate (13) relative to the direction in which the duct (20) is introduced into the hollow body (10).

4. Device according to claim 1, characterised in that the locking means are formed by at least one screw element (25) for fixing the lug (22) to the edge (16).

5. Beam for a motor vehicle dashboard cross-member, comprising a ventilation duct (20), characterised in that the ventilation duct (20) is positioned so as to be locked by at least one device according to claim 1.

6. Device according to claim 2, characterised in that the cut-out (15) comprises an edge (16) which extends substantially perpendicularly relative to the plate (13) and which is directed towards the outer side of the plate (13) relative to the direction in which the duct (20) is introduced into the hollow body (10).

7. Device according to claim 2, characterised in that the locking means are formed by at least one screw element (25) for fixing the lug (22) to the edge (16).

8. Device according to claim 3, characterised in that the locking means are formed by at least one screw element (25) for fixing the lug (22) to the edge (16).

9. Device according to claim 6, characterised in that the locking means are formed by at least one screw element (25) for fixing the lug (22) to the edge (16).

10. Beam for a motor vehicle dashboard cross-member, comprising a ventilation duct (20), characterised in that the ventilation duct (20) is positioned so as to be locked by at least one device according to claim 2.

11. Beam for a motor vehicle dashboard cross-member, comprising a ventilation duct (20), characterised in that the ventilation duct (20) is positioned so as to be locked by at least one device according to claim 3.

12. Beam for a motor vehicle dashboard cross-member, comprising a ventilation duct (20), characterised in that the ventilation duct (20) is positioned so as to be locked by at least one device according to claim 4.
